(19) United States
(12) Patent Application Publication
(10) Pub. No.: US 2016/0112302 A1
(43) Pub. Date: Apr. 21, 2016

(54) DYNAMIC VOICE OR DATA ROUTING SYSTEMS

(71) Applicant: Dynamic Voice, LLC, Chevy Chase, MD (US)

(72) Inventor: John B MACLEOD, Eastsound, WA (US)

(73) Assignee: DYNAMIC VOICE, LLC, Chevy Chase, MD (US)

(21) Appl. No.: 14/855,177

(22) Filed: Sep. 15, 2015

Related U.S. Application Data
(60) Provisional application No. 62/065,310, filed on Oct. 17, 2014.

(51) Int. Cl. H04L 12/707

(52) U.S. Cl. CPC H04L 45/22

(57) ABSTRACT

Systems and methods for voice and data routing are described. Systems and methods may include receiving a voice or data contact; receiving information regarding the voice or data contact; accessing information regarding one or more voice or data centers; determining a plurality of parameters related to routing the voice or data contact; determining weighting for the plurality of parameters; receiving values for the plurality of parameters; calculating a score for the one or more voice or data centers based on the received values and weighting; selecting, by a processor, a voice or data center to receive the voice or data contact based on the calculated score; and routing the voice or data contact to the selected voice or data center.

### FIELD OF THE INVENTION

The present invention relates to systems and methods for voice or data routing, and, more specifically, to systems and methods that can be used for dynamic routing to a plurality of call centers.

### BACKGROUND OF THE INVENTION

A call center is a system for receiving or transmitting a large volume of voice or data contacts by telephone, data connection, etc. Call centers may receive a large volume of incoming voice or data contacts from consumers regarding customer support, service inquiries, etc. Call centers may employ large numbers of agents that respond to or initiate contacts with customers. The agents may be centrally located in one or more physical locations, or may be remotely located and linked by communication links to the call center.

Existing systems may route voice or data contacts from one place to another. Existing systems use availability of one or more agents at a call center or the skill set of one or more agents at a call center to determine how a voice or data contact is routed and processed. Alternate systems may use current wait times at different locations to route voice or data contacts to minimize wait times for customers originating the voice or data contacts.

Improved systems and methods for voice or data routing are needed to increase efficiency and speed, as well as quality of service provided.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary system for dynamic voice or data routing according to one embodiment.

FIG. 2 shows an exemplary system for computational aspects of dynamic voice or data routing according to one embodiment.

FIG. 3 is a flow chart showing an exemplary method of dynamic voice or data routing according to one embodiment.

### DETAILED DESCRIPTION OF THE PREFERRED EMBODIMENTS

Systems and methods are described for using various tools and procedures for dynamic voice or data routing. In certain embodiments, the tools and procedures may be used in conjunction with one or more voice or data networks. The one or more global voice and data networks may interact with one or more voice or data centers. The one or more voice or data centers may be selected from one or more of call centers, automated call systems, technical monitoring and control centers, etc. The examples described herein relate to voice or data call centers for illustrative purposes only. The systems and methods described herein may be used for many different industries and purposes, including purchase transactions, technical support, product/service support, financial institution support, including investment banking, customer service, information technology help desks, and/or other customer support applications, whether virtual, automated or with voice or data agents. In particular, the systems and methods may be used for any industry or purpose where dynamic routing of information is needed to increase service efficiency, quality, and/or reduce costs. For multi-step processes or methods, steps may be performed by one or more different parties, servers, processors, etc.

Systems and methods for dynamic routing may receive input from one or more voice or data networks. The input received may include one or more voice or data contacts. The one or more voice or data contacts may be voice contacts, such as, but not limited to calls from customers of one or more clients. Voice contacts may be analog or digital and wireless or wired. Any type of web-based query may be considered as the voice or data contacts. The one or more voice or data contacts may be data from customers of one or more clients, such as emails, text message, live chat sessions, etc. For non-voice contacts, front end processing may be used to facilitate use with dynamic routing as described herein.

One or more parameters may be used to select a routing instruction for each incoming voice or data contact. In certain embodiments, a plurality of parameters may be used to determine how to route each incoming voice or data contact. The plurality of parameters may be two or more, three or more, four or more, five or more, six or more, seven or more, or higher numbers of parameters. The plurality of parameters used for each incoming voice or data contact may be predetermined or may be adjusted in real-time, near real-time, or at other intervals. In certain embodiments, a client may determine the particular parameters to be used for each incoming voice or data contact. The particular parameters may be based on one or more rules, which may consider information regarding the particular incoming voice or data contact. The client may specify use of different parameters and/or different treatment of one or more particular parameters based on the particular incoming voice or data contact.

In certain embodiments, each of the parameters may be determined upon receiving the incoming voice or data contact. In certain embodiments, one or more of the parameters may be predetermined prior to receiving the incoming voice or data contact. The parameters may be determined from characteristics of the incoming voice or data contact, or may be determined by reference to one or more characteristics of one or more voice or data centers or one or more agents at the one or more voice or data centers. Characteristics of the one or more voice or data centers or one or more agents at the one or more voice or data centers may be received from third party sources, such as the one or more voice or data centers and/or may be stored in one or more databases internal or external to the system.

The parameters may be used to dynamically route one or more voice or data contacts to selected voice or data centers; including specific individuals in the voice or data centers. In certain embodiment, one or more of the voice or data centers may be owned by different companies/entities. Therefore, the routing may not take place between voice or data centers with a business/ownership relationship. The selected voice or data center or individual may be chosen using one or more parameters, where the parameters are weighted and related to other parameters by relationships. The systems and methods may consider the weighted parameters to determine a selected voice or data center for each of the incoming voice or data contacts. The dynamic routing may provide for a network of linked voice or data centers that may function similarly to a single voice or data center. Components of the network of linked voice or data centers may be physically and/or functionally separate. In some embodiments, the agents could work in individual locations or even out of their homes, lowering the cost of call centers and enlarging the number of potential agents available. This would also provide greater flexibility for the agents, who could even perform their jobs remotely on mobile devices.

Although not required, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java,.NET Framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

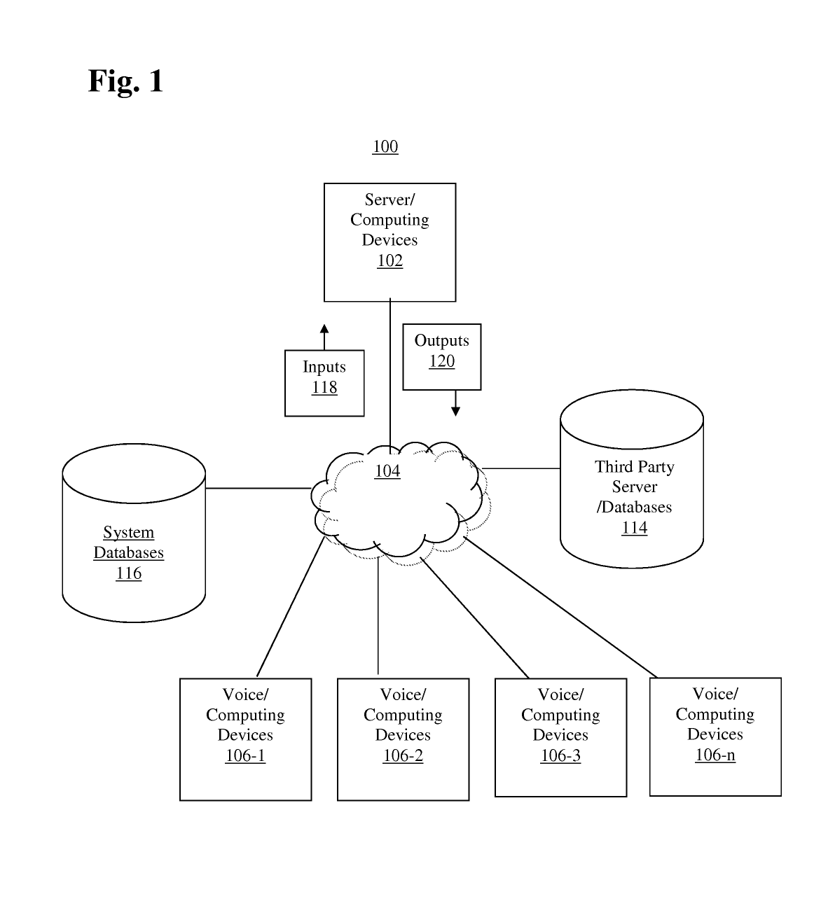

FIG. 1 shows an exemplary system 100 for dynamic voice and data routing according to one embodiment. In this exemplary implementation, system 100 may include one or more servers/computing devices 102 (e.g., server 1, server 2, . . . , server n) operatively coupled over network 104 to one or more voice/computing devices 106-1 to 106-n, which may include one or more consumer computing devices, one or more provider computing devices, one or more remote access devices, etc. The one or more servers/computing devices 102 may also be operatively connected, such as over a network, to one or more third party servers/databases 114 (e.g., database 1, database 2, . . . , database n). The one or more servers/computing devices 102 may also be operatively connected, such as over a network, to one or more system databases 116 (e.g., database 1, database 2, . . . , database n). Various devices may be connected to the system, including, but not limited to, client computing devices, consumer computing devices, provider computing devices, remote access devices, etc. This system may receive inputs 118 and outputs 120 from the various computing devices, servers and databases.

Server/computing device 102 may represent, for example, any one or more of a server, a general-purpose computing device such as a server, a personal computer (PC), a laptop, a smart phone, a tablet, and/or so on. Networks 104 represent, for example, any combination of the Internet, local area network(s) such as an intranet, wide area network(s), cellular networks, WIFI networks, and/or so on. Such networking environments are commonplace in offices, enterprise-wide computer networks, etc. Client and/or customer computing devices 106, which may include at least one processor, represent a set of arbitrary computing devices executing application(s) that respectively send data inputs to server/computing device 102 and/or receive data outputs from server/computing device 102. Such computing devices include, for example, one or more of desktop computers, laptops, mobile computing devices (e.g., tablets, smart phones, human wearable device), server computers, and/or so on. In this implementation, the input data comprises, for example, data or call information, system resources, parameters, weightings, and/or so on, for processing with server/computing device 102. In one implementation, the data outputs include, for routing instructions, reports, example, emails, templates, forms, and/or so on. Embodiments of the present invention may also be used for collaborative projects with multiple users logging in and performing various operations on a data project from various locations. Embodiments of the present invention may be web-based, smart phone-based and/or tablet-based or human wearable device based.

In this exemplary implementation, server/computing device 102 includes at least one processor coupled to a system memory. System memory may include computer program modules and program data.

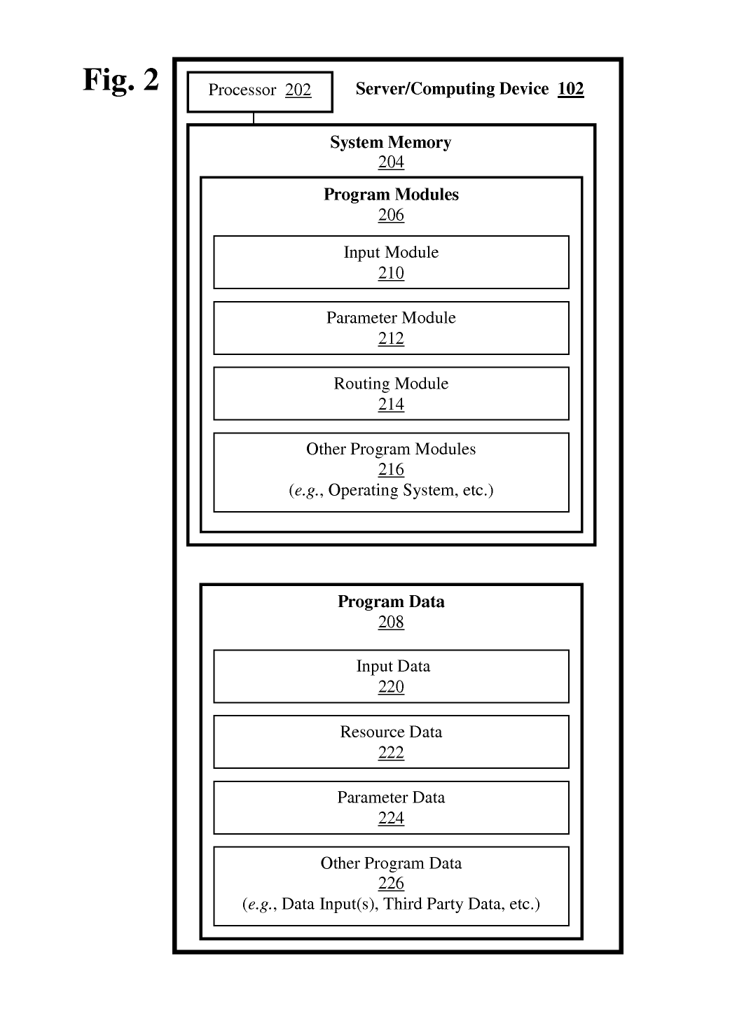

In this exemplary implementation, server/computing device 102 includes at least one processor 202 coupled to a system memory 204, as shown in FIG. 2. System memory 204 may include computer program modules 206 and program data 208. In this implementation program modules 206 may include input module 210, parameter module 212, routing module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include input data 220, resource data 222, parameter data 224, and other program data 226 such as data input(s), third party data, and/or others.

Certain embodiments described herein may be directed to systems for routing voice or data contacts to one or more voice or data centers. Certain embodiments may combine a plurality of voice or data centers, each of which can utilize voice or data center agents and/or automated response systems, in such a way that the system may function as a single voice or data center. In certain embodiments, both voice or data center agents and automated systems may be used for voice or data contacts in a single system. Voice and/or data routing to these voice or data centers may be determined in real-time or near real-time by a dynamic routing system. In certain embodiments, routing decisions, such as selecting a voice or data center to receive a voice or data contact, may be accomplished in less than approximately 5 seconds, less than approximately 2 seconds, less than approximately 1 second, less than approximately 0.5 seconds, less than approximately 0.2 seconds, less than approximately 0.1 seconds, less than approximately 0.05 seconds, less than approximately 0.03 seconds, less than approximately 0.02 seconds, less than approximately 0.01 seconds, etc. These times may be used with Route Before Termination (RBT) voice or data contacts, in certain embodiments. The times may also apply to voice or data contacts that are terminated and then forwarded. In certain embodiments, the dynamic routing system may be automated. Certain embodiments may apply to calls that are routed before reaching a voice or data center, and not calls that are routed after reaching a voice or data center.

The following is an exemplary illustration of a potential dynamic routing operation according to one embodiment. The particular values, parameters used, etc. are for illustrative purposes only and are not intended to limit this disclosure.

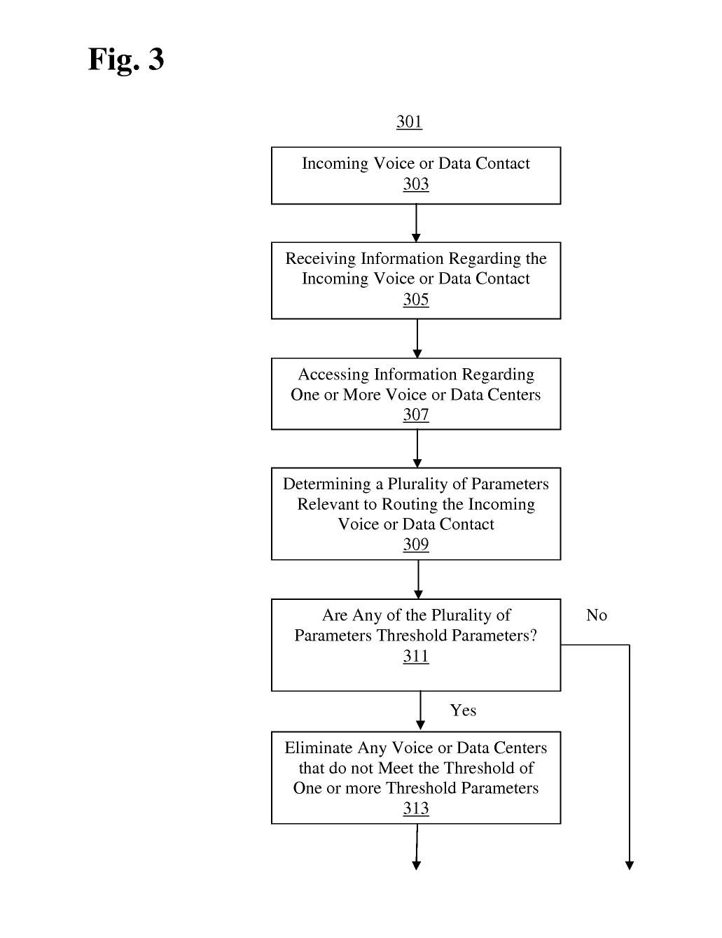

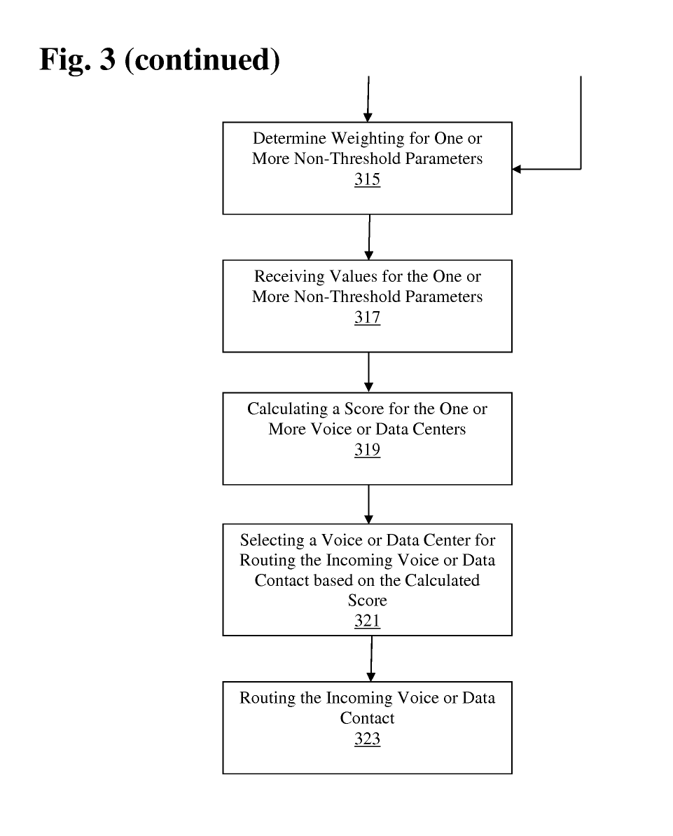

FIG. 3 illustrates an exemplary method 301 for dynamically routing an incoming voice or data contact. An incoming voice or data contact 303 may be received by the system. The method may receive, extract, access, and/or determine one or more characteristics of the incoming voice or data contact 305, such as a full or partial identification of the voice or data contact source, geographic location of the incoming voice or data contact, etc. In certain embodiments, the method may extract information from the incoming voice or data contact. In certain embodiments, the method may receive information regarding the incoming voice or data contact. This information may then be used in the routing method. For example, when a phone number in a system database is dialed, the system database may determine one or more items of information regarding the incoming voice or data contact. In certain embodiments, Dialed Number Identification Service (DNIS) and/or Caller Identification (CID), the telephone number dialed and the identity of the phone that called the number, may be used. The telephone number dialed may be used to access specific parameters to be used by the dynamic routing method for specific service(s) in support of a specific client. Caller identification may be used to identify a specific client and/or their geographic location. In addition, the database may have specific voice preferences, either for a specific voice or data contact or for a particular client/customer. Voice preferences may mean agents in a particular geographic area (or not in a particular geographic area); preference for a female or a male agent; or, for a particular type of voice; i.e., an English banker or a California valley girl. Some customers may prefer to talk to a person from a particular country or countries rather than someone from a different set of countries. Or, it may be that the client (company) may believe that people who live in one group of countries may have more background knowledge related to the type of product or service they are providing than people from a different group of countries. In the second area, patients may be more comfortable speaking to an agent of the same gender when discussing medical issues. For certain services, the required gender of the agent may be included in a skill set definition. In the third area, certain accents and/or dialects may be desired wherever the voice or data contact is routed. Data on the voice desired may be sent with the voice or data contact. In certain embodiments, the voice preference may be one of the factors that determines where the voice or data contact is routed. Optionally, this information may also be in the cloud or in the call centers' databases, if it is not used for routing. A cloud may be, but is not limited to, internet-based computing in which large groups of remote servers are networked to allow centralized data storage, and online access to computer services or resources. This information could be sent as data along with a voice call.

The method may utilize these database parameters and/or one or more parameters related to one or more available voice or data centers. The method may access information regarding the one or more voice or data centers 307. The method may access and/or receive a matrix of available voice or data centers and current data regarding each of them. The information may be current data regarding the one or more voice or data centers, such as real-time data, near real-time, or the most current updated information. For example, the information may include current skill sets of agents on-line, wait times, call center noise environment, etc. Other information may include data from the voice or data centers' business units, such as pricing data, which can be changed at any time. In certain embodiments, real-time pricing may allow a client to charge at one price for a first voice or data contact and a different price for a subsequent voice or data contact. This may be case even for voice or data contacts to a single voice or data contact agent. A system database may log a price for a particular voice or data contact and then the duration for that particular voice or data contact. The duration may be obtained and/or determined by the voice or data center's automatic call distribution (ACD) database, or an equivalent system. Other information may include quality data from an independent monitoring center or any other internal or external source.

With Route before Termination (RBT), a routing decision may be made within the maximum time allowed by the network being used so the incoming voice or data contact can be routed without being terminated at the processors' location. When RBT is not used, which could vary on a call by call basis, the same or similar routing algorithm may be used, but other options, such as leaving a voice mail, providing a time for callback, or requesting a call back may be provided by the processing system.

The method may determine a plurality of parameters relevant to routing the incoming voice or data contact 309. The relevant parameters may be predetermined by the client or the system. The method may determine whether any of the plurality of parameters are threshold parameters 311. Threshold parameters are parameters that may have a binary response, such as Yes/No type criteria. For example, a threshold parameter may be whether there are any agents available at a particular voice or data center with the appropriate skills to handle the incoming voice or data contact.

In certain embodiments, the threshold parameters, if any, may be evaluated before any non-threshold parameters, such as those that utilize weighting. This may reduce calculation time by eliminating voice or data centers that cannot handle the incoming voice or data contact. Voice or data centers not meeting the threshold standard for each of the threshold parameters may be eliminated from consideration for the routing method 313.

For example, one or more of the following threshold parameters may be used in exemplary embodiments. Voice or data centers may be found in a list, matrix, etc. in various embodiments.

Are there any voice or data centers/companies that the relevant client for the incoming voice or data contact will not use? If so, then these voice or data centers may be removed from the matrix.

Are there call centers located in a geographic area that the client will not use? If so, then these call centers may be removed from the matrix.

Which voice or data centers have agents on-line with the specific skill sets required by the client? These call centers may be retained in the matrix and the others may be removed.

Are there voice or data centers in the matrix that are charging more than the maximum price that the client will pay? If so, these voice or data centers may be removed from the matrix. It should be noted that this parameter may be dependent on the specific caller; i.e., the client may be willing to pay more for service to a high value customer than for a low value customer.

Are there voice or data centers in the matrix with lower quality monitoring scores than the client will allow? If so, these voice or data centers may be removed from the matrix. This parameter may also depend on the specific caller because a lower quality monitoring score may be acceptable for a low value customer, but not a high value customer.

What is an acceptable wait time for this particular customer/client? If this is a threshold parameter, and, if there are call centers that satisfy this criterion, they may be kept in the matrix.

Of the remaining voice or data centers in the matrix, are any of them on the client's “preferred” list? If so, a weighting factor may be applied to the voice or data centers in this category.

Continuing this example, all remaining voice or data centers may have acceptable quality, available agents with the required skill sets, and offer services at an acceptable price. Some of them may be in the preferred category.

Weighting may be determined for any non-threshold parameters 315. This may allow for ranking of the one or more voice or data centers remaining in the list or matrix. Values may be accessed and/or received for the non-threshold parameters 317. A score may be calculated for the one or more voice or data centers based on the values received for the non-threshold parameters 319. A voice or data center for routing the incoming voice or data contact may be selected based on the calculated score 321. The incoming voice or data contact may then be routed 323.

In this example, assume the client has specified that the following weighting factors are to be used:
Quality as determined by independent monitoring is 60% of the score;
Wait time is 25% of the score;
Cost is 15% of the score; and
A 10% bonus is awarded if a call center is on the client's preferred list.

On a scale of 1 to 10, assume that call centers A, B and C have the following values:
Quality—A is 8; B is 4; C is 9
Wait time—A is 5; B is 9; C is 7
Cost—A is 6; B is 2; C is 5
Preferred list—only A

Therefore, Call Center A may receive a weighted score of 7.645, Call Center B may receive a weighted score of 4.95, and Call Center C may receive a weighted score of 7.9, so the call is routed to Call Center C.

An output may include a determination of where to send each incoming voice or data contact. The output routing instructions may be determined prior to call termination or after call termination. Route before termination (RBT) routing may require that a decision be made, and routing instructions returned, in a small amount of time. When a voice or data contact is routed in this manner, it may be sent to the selected voice or data center along with digital data that specifies the type of voice or data contact, the client customer, how the voice or data contact is to be answered and other information associated with the voice or data contact. Data only applications may be handled in a similar way; i.e., digital data may be routed to a specific automated system as determined by the dynamic routing system, and may determine how the routed data is processed.

The above example contained several threshold parameters. In certain embodiments, however, all of the parameters, except for the presence of required agent skill sets, may be non-threshold parameters, i.e., may have weighted values. In certain embodiments, even required agent skill set parameters may be non-threshold parameters. For example, if one or more agents have the minimum required skill set, the degree of agent proficiency may be a weighted value. Therefore, a matrix of parameters may include weighted values for agent skill sets, service cost, preference of centers/companies, wait times, service quality and call center location. These values may change, not only based on the client, but also the specific customer and his or her location.

In certain embodiments, parameters may vary with time (e.g., cost, wait times, and agent skill sets); indeed, some of the parameters could even be modified by the caller, who would be given different choices depending on the service plan they purchased or on the cost for the requested information. In the example, the selection of a specific voice or data center was based on values at one specific time. In alternative methods, this may not be the case. For example, by tracking agent availability (wait times) at different centers over a period of time and, potentially, of agents with specific skill sets, there may be definitive trends; e.g., the wait times may be steadily increasing at a rapid pace, so even though at this exact time, wait times may be acceptable, a projection could show that by the time the voice or data contact is answered, the wait time will most likely exceed a maximum allowed wait time. Certain embodiments may integrate the trends of multiple parameters to optimize results.

Factors that affect routing decisions may change very quickly and from multiple sources. Independent monitoring results may update the database at any given time. The business unit of voice or data center companies may change their pricing in real-time or at other frequencies; voice or data centers may change their staffing, which can result in increased or decreased wait times, and call traffic can quickly increase or decrease, sometimes in predictable ways, which may also be used by the method. The model may be updated at any time to optimize performance of the dynamic routing.

In certain situations, the dynamic routing systems and methods may not be able to find an acceptable voice or data center match based on the input parameters provided. As it is necessary to route the incoming voice or data contact, a solution may be provided in these situations. A set of allowable solutions may be determined and may vary on a client by client basis. Options may include varying what is considered acceptable for specified parameters or sending the call to an automated system where a variety of options could be provided.

As described herein, voice or data centers may be both those call centers using agents as well as automated call systems. Embodiments described herein may be used by automated systems, which are included in the definition of voice or data centers. Many services described here may be provided by servers that utilize speech recognition, coupled with intelligent software linked to extensive databases, and text to speech (TTS) for caller responses. The use of speech recognition and TTS for various voices may be such as are known in the art, for example U.S. Pat. No. 7,275,032 describes many such systems and is incorporated by reference herein in its entirety. Alternatively, speech recognition and TTS for various voices may be methods designed to improve the systems described herein.

Embodiments described herein may be designed to not be dependent on the type of communications utilized by a network. Voice communications may be either analog or digital and the network protocol used, e.g., VoIP (Voice over Internet Protocol), may not be restricted.

One reason for integrating a large number of global call centers into a single, virtual voice or data center in a seamless and intelligent manner is that service quality can be improved and cost can be reduced. In addition, service offerings can be identical no matter where the voice or data contact is routed and the clients' requirements may be met, even as network traffic is continuously changing.

In existing systems, if a client uses more than one voice or data center for a particular client's services, the network provider's Point of Presence (PoP), basically a network routing switch, may route a percentage of the voice or data contacts to each voice or data center, as defined by the client. These percentages may be changed by the client and, for most networks, can also automatically change based on the time of day; e.g., from 8 am to 5 pm, 45% to location A, 25% to location B and 30% to location C, then from 5:00.01 pm to 7:59:59 am, 60% to location A, 40% to location B and no calls to location C. This is an unintelligent system that does not react to changing network conditions and does not use dynamic routing parameters. Although agent availability from a voice or data center is sometimes used, this is typically an “either/or” choice; i.e., agent availability or percentage call routing.

Another technique used is call overflow. If no agents are available at location A, calls can be forwarded to location B. This is also not an intelligent system. In both approaches, all of the participating call centers are either owned by the call center client or operated for them under contract.

By contrast, with the approach described herein, hundreds or thousands of call centers, owned by a multitude of clients (companies), may be integrated into a single virtual call center. For instance, calls may be routed as if there exists one, very large call center, with hundreds of thousands of agent positions.

Certain embodiments may utilize a plurality of factors that may be evaluated and weighted to determine the optimum routing solution for each voice or data contact. The plurality of factors may be evaluated simultaneously or in a series. Certain embodiments may route voice or data contacts via a network to a large number of call centers, potentially owned by different companies, based on a plurality of parameters.

### Dynamic Routing Parameters

The following is an exemplary list of potential parameters used in the systems described herein. Various embodiments may utilize one or more parameters to dynamically route data and voice contacts. Each of the parameters may have one or more relationships with one or more other parameters. For example, a first parameter may affect the value, weighted or unweighted, of a second parameter used to determine routing. The first parameter may be related to a plurality of other parameters through various relationships. Parameters may be related to a specific client and/or may be call specific.

Certain embodiments may utilize a matrix of parameters. One or more parameters may be used for each incoming voice or data contact. Different combinations of parameters may be used for different voice or data contacts. In certain embodiments, for example, a first parameter may be an indication of whether an agent with the required skill set is available. This first parameter may be used in combination with one or more of the other parameters, where the one or more other parameters are related to the first parameter by one or more relationships.

In certain embodiments, each of the parameters may be weighted. One or more relationships between the parameters may affect the weighting. The weighting can be changed automatically based on interactions between the parameters. Updates may be based on specific clients and/or callers. The weighting changes can be based on a pattern of changes, not necessarily the current conditions, and may predict future conditions as input into the weighting changes. Trends in parameters values may be determined to affect weighting of the parameters.

Certain embodiments may utilize weighted values for one or more parameters. The weighted values may change based on data from a multitude of sources. The weighting of the values may also change. In certain embodiments, the client may change the weighting of the values, such as the percentages allocated to each parameter. The weighted values may also change the weighting of values. For example, for a particular client's high value customers the client does not care about cost and always wants the highest level of service available. So, for this client, the percentage values for wait time and quality (monitoring scores) may make up a high percentage of the matrix score and other values, including cost, may make up a relatively low percentage. Other companies may have cost as their highest percentage parameter and may value wait times and quality much lower. In these types of cases, the relative percentages, for a particular customer, would often stay the same until the client changes them. There can also be cases, however, where real-time data can change the relative value percentages. For example, a client may say that cost is most important and they do not care about wait times (unless, for example, they are above five minutes). If wait times are above five minutes, the client may want the percentage allocated to cost to go down and the amount allocated to wait times to increase. Having a different matrix for each client, having it vary for different customers of the same client, and also changing the relative weighting of parameters based on real-time data may be used in certain embodiments. Results may vary depending on real-time data, but routing decisions may also be different on a client-by-client basis.

Data may be provided in real-time, near real-time, at predetermined intervals, etc. Data may be generated by automated systems and/or may be generated by manual entry. In addition, the specific methods that the weighted values are used may be changed. The change may occur in real-time, near real-time, at predetermined intervals, etc. The changes may be automated or manually updated. Changes may be based on one or more business rules, or qualitative or quantitative observations. As an example of a business rule, a client's Class A customers may have different matrix allocations than Class B customers. Another business rule example may relate to the importance of cost versus wait time parameters when wait times increase, as described above. An example of qualitative/quantitative observations may be the use of monitoring scores as one of the factors when routing calls. Monitoring evaluations may result in specific numbers (1 through 10, for example) even though there may be many different quality factors that were evaluated by the monitoring team, some of which may be qualitative (subjective); e.g., was an agent's pronunciation clear, and others which may be quantitative (measured); e.g., how long after the connection was made did it take the agent to speak a greeting.

The following are exemplary parameters:

### Agent Skill Set

A parameter may include whether an agent with one or more skill sets required to properly service an incoming voice or data contact is available. The parameter may consider a skill set of an available agent.

Certain embodiments may track the status of each agent at a plurality of voice or data centers. One or more databases may contain information related to the one or more skill sets of each agent. This parameter may be weighted, as with other parameters. The value of one or more parameters may vary based on real-time conditions and/or manual inputs. The databases may also contain information from customer feedback for individual/voice or data centers, time required in the past to resolve issues, and success rates.

In certain embodiments, agent skill set may be combined with one or more other parameters as agent skill set may be considered a threshold condition for routing a voice or data contact. For example, if there are no agents available a particular voice or data center, then the call will not be sent to that voice or data center.

### Agent Preferences

A parameter may include agent preferences. The parameter may consider whether there are agents at a particular voice or data center that are preferred, or mandated, by a client.

The client may change this preference in real-time, or at any other interval, and the importance of this parameter can be changed in real-time, or at any other interval. The parameter itself may be weighted. The weighted value can be changed by the client at any time.

If there are no agents available that are preferred by the client, the client can specify whether another voice or data center can be used or not; if another voice or data center can only be used if the wait time for agents with a specific skill set exceeds a specific number; or, if an automated support technique is to be used and what that support technique is; e.g., to leave a phone number for a call back or utilize an automated voicemail tree.

### Quality Ranking of Agents

A parameter may include quality ranking of agents. The parameter may consider the quality ranking of all agents capable of providing a requested service.

A quality monitoring team may randomly evaluate the agents, automated systems, and/or voice and data centers in a network. In certain embodiments, the evaluations may be entered and considered in real time or at any other interval. In addition, the clients may have the option of performing their own evaluations. One or more evaluations may be combined into a single quantitative score. This parameter may be given a weighted value. The weighted value of this parameter can be changed at any time and the values themselves may be updated each time another evaluation is added. Each client can determine how much weight this parameter may have for their voice or data contacts and can also determine if a minimum score is required as a pre-requisite to receive any of their voice or data contacts.

### Cost of a Voice or Data Contact

A parameter may include cost of a voice or data contact. Certain embodiments may consider the cost of a voice or data contact, such as the wholesale cost for each voice or data center to provide their services. Cost of a voice or data contact may be determined on a per transaction basis, such that the cost is for a particular voice or data contact. In certain embodiments, the cost of a voice or data contact may be time based, such as based on the length of time services are provided. In certain embodiments, the cost of a voice or data contact may be occurrence-based, such that there is a set or fixed fee for a particular voice or data contact. Various combinations of these types of costs or other cost determinations may be used.

This parameter may receive a weighted value. Voice or data centers may determine the price of their services and this price can change by time of day, day of the week, or for specific days. Voice or data centers can change their pricing in real time, which could quickly result in increased or decreased call traffic. Although certain embodiments may have standard parameter weights, all of which can be changed in real time by a network operator, clients can change this standard parameter's weighting as well as specify a maximum price that they are willing to pay.

Certain embodiments may provide for interdependencies between parameters, thereby resulting in a matrix of weighted parameters. As an example, a client may agree to a higher maximum price if the quality monitoring parameter is one value but this maximum price may be lower if the quality monitoring parameter is lower. Interdependencies between parameters may allow, for example, that acceptable monitoring and price parameters may be different if there is no wait time than if there is a wait time.

### Origination of the Voice or Data Contact

A parameter may include origination of the voice or data contact. In certain embodiments, a location where a voice or data contact originates can receive a weighted parameter value.

A client may decide that voice or data contacts from a specific area are potentially more valuable than voice or data contacts from another geographic area and, therefore, should receive better service. As such, for voice or data contacts from preferred areas, the client may be willing to pay a higher price for better service, such as decreased wait time Likewise, voice or data contacts from other geographic areas considered of less value could result in a lower maximum price. Political factors could also influence where voice or data contacts are allowed to go; e.g., voice or data contacts from one country may not be allowed to be sent to a specific country or list of countries for some clients.

### Customer Classification

A parameter may include customer classification. In certain embodiments, different classes of customers can receive a different weighted parameter value.

A bank, for example, may give one telephone number to customers with over $100,000 in the bank and a different telephone number to customers with less than $100,000 in their accounts or there could be many different classes of customers. The value of this parameter may result in improved service, most likely at a higher cost, for those customers with larger account balances. This may also result in reduced services, most likely at a lower cost, for customers with lower account balances.

### Voice or Data Center Performance

A parameter may relate to voice or data center performance. In certain embodiments, a parameter may reflect how a voice or data center is operating, such as normally, inoperative, or under degraded service.

If a voice or data center is inoperative, then it may not receive any voice or data contacts but, depending on the type of outage, this voice or data center could still receive automated calls. Systems may also specify routing procedures for widespread outages.

This set of parameters can be expanded, if necessary or desired. In certain embodiments, the parameters described herein may be a minimum set of parameters, but additional parameters, with various weighting values, may be added at any time.

Certain embodiment may not only intelligently route the voice or data contacts based on various parameters, but may also capture data from the voice or data center and correlate it with data used to route the voice or data contact in ways that are not needed with current routing technologies. An example is that the price for two sequential voice or data contacts to the same call center and to the same agent and for the same client, may have different costs because costs can change on a real-time basis. Calculating these costs may require uniquely identifying each voice or data contact, associating the per minute cost for each voice or data contact, and then correlating it with the time that the agent was on the voice or data contact, which may be provided by the voice or data center via a data link.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A computerized method of voice or data routing, the computerized method comprising the steps of:
receiving a voice or data contact;
receiving information regarding the voice or data contact;
accessing information regarding one or more voice or data centers;
determining a plurality of parameters related to routing the voice or data contact;
determining weighting for the plurality of parameters;
receiving values for the plurality of parameters;
calculating a score for the one or more voice or data centers based on the received values and weighting;
selecting, by a processor, a voice or data center to receive the voice or data contact based on the calculated score; and
routing the voice or data contact to the selected voice or data center.

2. The method of claim 1, wherein the plurality of parameters are selected from the group consisting of: agent skill sets, agent preferences, quality ranking of agents, cost of a voice or data contact, origination of the voice or data contact, customer classification, voice or data center performance, and combinations thereof.

3. The method of claim 1, wherein the plurality of parameters are agent skill sets, and one or more parameters selected from the group consisting of: agent preferences, quality ranking of agents, cost of a voice or data contact, origination of the voice or data contact, customer classification, voice or data center performance, and combinations thereof.

4. The method of claim 1, further comprising determining whether any of the plurality of parameters are threshold parameters, and eliminating voice or data centers that do not meet the threshold of each of the threshold parameters.

5. The method of claim 4, wherein the eliminating voice or data centers that do not meet the threshold of each of the threshold parameters occurs before determining weighting of non-threshold parameters.

6. The method of claim 1, further comprising ranking the one or more voice or data centers after calculating a score.

7. The method of claim 1, wherein the information regarding the voice or data contact is a number dialed and a caller identifier.

8. The method of claim 1, wherein the information regarding one or more voice or data centers is a matrix of current information.

9. The method of claim 1, wherein the plurality of parameters related to routing the voice or data contact is predetermined by a client.

10. The method of claim 1, wherein the weighting for the plurality of parameters is predetermined by a client.

11. The method of claim 1, wherein the weighting of the plurality of parameters are automatically updated in real-time.

12. The method of claim 11, wherein the updating is based on patterns of changes in data.

13. The method of claim 1, wherein the selecting is completed in less than approximately one second when using Route Before Termination (RBT).

14. The method of claim 1, wherein the selected voice or data center is an automated voice or data system.

15. The method of claim 1, wherein the relationships determine how a change in weighting of one parameter affects weighting of another parameter.

16. The method of claim 1, wherein the plurality of parameters is more than two parameters.

17. The method of claim 16, wherein the plurality of parameters is more than three parameters.

18. The method of claim 17, wherein the plurality of parameters is more than four parameters.

19. The method of claim 18, wherein the plurality of parameters is more than five parameters.

20. The method of claim 19, wherein the plurality of parameters is more than six parameters.
